(19) United States
(12) Patent Application Publication
(10) Pub. No.: US 2011/0243353 A1
(43) Pub. Date: Oct. 6, 2011

(54) Speaker Apparatus

(75) Inventors: Susumu TAKUMAI, Hamamatsu-shi (JP); Yusuke Konagai, Hamamatsu-shi (JP); Kazunori Tanaka, Hamamatsu-shi (JP)

(73) Assignee: Yamaha Corporation, Hamamatsu-shi (JP)

(21) Appl. No.: 13/075,608

(22) Filed: Mar. 30, 2011

(30) Foreign Application Priority Data
Mar. 31, 2010 (JP) 2010-082004

(51) Int. Cl. H04R 5/02

(52) U.S. Cl. 381/300

(57) ABSTRACT

A speaker apparatus includes: a first outputting unit that has a first speaker unit group in which a plurality of speaker units are arranged, and that outputs a supplied audio signal from the first speaker unit group as a sound which is directed in a direction; a second outputting unit that has a second speaker unit which is placed so that a front direction of the second speaker unit in which a frontage of the second speaker unit faces is different from a front direction of the first speaker unit group in which a frontage of the first speaker unit group faces, and that outputs a supplied audio signal from the second speaker unit as a sound; and a supplying unit that separates an input audio signal into an audio signal in a low-frequency band where a frequency band which is higher than a first frequency is attenuated, and an audio signal in a high-frequency band where a frequency band which is lower than a second frequency is attenuated, the supplying unit that supplies the audio signal in the low-frequency band to the first outputting unit, and that supplies the audio signal in the high-frequency band to the second outputting unit.

### BACKGROUND OF THE INVENTION

The present invention relates to a technique for providing a surround effect by using a speaker array.

A method has been proposed in which a directionality is given to an audio signal by a speaker array, and the signal is caused to reach the listener by wall reflection, thereby realizing a surround effect. For example, JP-A-6-205496 discloses a related-art technique in which audio signals of right and left channels from a speaker array disposed in front of the listener are reflected from a wall to reach the listener. According to the technique, a surround effect can be given while a sound image is localized in directions toward right and left walls with respect to the listener.

When an excellent surround feeling is to be obtained by using a speaker array, the directionality of a sound must be enhanced. In order to enhance the directionality of a sound, it is necessary to use many speaker units. This is because the directionality of a sound of a long wavelength cannot be enhanced without increasing the whole width of the speaker array. In the case where the gap of adjacent speaker units constituting the speaker array is not narrowed, when a directionality is given to a sound of a wavelength which is shorter than the limit derived from the spatial sampling theorem, a grating lobe is generated.

FIGS. 7A and 7B are diagrams illustrating an influence of a grating lobe which is given to the listener 2000. A related-art speaker array apparatus is placed in front of the listener 2000 in a room 1000, and outputs a sound (main sound beam MB) directed in the main direction in order to cause a sound to reach the listener 2000 by using wall reflection. In the description of the example, the case where the main beam is a sound of 4 kHz will be exemplified. FIG. 7A is a diagram illustrating an influence of a grating lobe in the case of a speaker array apparatus 1RN in which the gap of adjacent speaker units is narrow, and FIG. 7B is a diagram illustrating an influence of a grating lobe in the case of a speaker array apparatus 1RW in which the gap of adjacent speaker units is twice that of the speaker array apparatus 1RN.

In the case of the speaker array apparatus 1RN, since the gap of adjacent speaker units is narrow, there is no direction in which the output intensity is large, other than the direction of the main sound beam MB, as in the polar pattern shown in FIG. 7A. By contrast, in the case of the speaker array apparatus 1RW, the gap of adjacent speaker units is long, and there is a direction in which the intensity is similar to that of the output in the direction of the main sound beam MB, as in the polar pattern shown in FIG. 7B. When the speaker array apparatus 1RW outputs the main sound beam MB, therefore, the apparatus outputs also a subsound beam SB in the direction. This additional lobe seen in the polar pattern is so-called “a grating lobe” because it is caused by the same mechanism as Bragg diffraction of light by a diffraction grating. When the direction of the subsound beam SB is oriented toward the listener 2000, the listener listens to the sound which is to be listened in the direction of the wall, also in the direction of the speaker array apparatus 1RW. The sound reaches the listener in advance of the sound in the direction of the wall. Therefore, the localization sensation along the direction of the wall is lost, and the surround feeling is lowered. The frequency distribution of the subsound beam SB is in a band which is equal to or higher than a specific frequency that is determined by the gap of the speaker units. When the frequency is within a frequency region which is in the audible range, and in which the human audio sensitivity is high, not only the localization sensation but also the sound quality are caused to be deteriorated.

In order to obtain a surround feeling by using a speaker array, as described above, the gap of speaker units must be narrowed, a large number of speaker units are necessary, and hence a very high cost is required.

### SUMMARY

It is therefore an object of the invention to provide a technique in which, even when a speaker array apparatus is used in which the gap of speaker units is widened and the number of used speaker units is reduced, the localization sensation of a sound image is prevented from being impaired, while deterioration of the sound quality is suppressed, thereby providing a surround feeling.

In order to achieve the object, according to the invention, there is provided a speaker apparatus comprising: a first outputting unit that has a first speaker unit group in which a plurality of speaker units are arranged, and that outputs a supplied audio signal from the first speaker unit group as a sound which is directed in a direction; a second outputting unit that has a second speaker unit which is placed so that a front direction of the second speaker unit in which a frontage of the second speaker unit faces is different from a front direction of the first speaker unit group in which a frontage of the first speaker unit group faces, and that outputs a supplied audio signal from the second speaker unit as a sound; and a supplying unit that separates an input audio signal into an audio signal in a low-frequency band where a frequency band which is higher than a first frequency is attenuated, and an audio signal in a high-frequency band where a frequency band which is lower than a second frequency is attenuated, the supplying unit that supplies the audio signal in the low-frequency band to the first outputting unit, and that supplies the audio signal in the high-frequency band to the second outputting unit.

The audio signal in the low-frequency band may be mixed with the audio signal in the high-frequency band which is to be output to the second outputting unit, at a predetermined ratio.

A relationship between an output level of the sound output from the first outputting unit and an output level of the sound output from the second outputting unit may be changed in accordance with a relationship between the direction in which the sound output from the first outputting unit is directed and the front direction of the second speaker unit.

The first frequency may be determined in accordance with a relationship between the direction in which the sound output from the first outputting unit is directed and a position which the sound is to reach.

The speaker apparatus may further include: a setting unit that sets the direction in which the sound output from the first outputting unit is directed; and a moving unit that moves the front direction of the second speaker unit to a direction corresponding to the direction set by the setting unit.

### BRIEF DESCRIPTION OF THE DRAWINGS

FIG. 1 is a block diagram showing the configuration of a speaker apparatus of an embodiment of the invention.

FIGS. 2A and 2B are views showing the appearance of the speaker apparatus of the embodiment of the invention, and the manner of arranging speaker units.

FIG. 3 is a diagram showing an acoustic processing portion in the embodiment of the invention.

FIG. 4 is a view illustrating frequency characteristics of high- and low-pass filter portions in the embodiment of the invention.

FIG. 5 is a view illustrating paths of sounds output from the speaker apparatus of the embodiment of the invention, to the listener.

FIG. 6 is a diagram illustrating the configuration of a speaker apparatus of Modification 3 of the invention.

FIGS. 7A and 7B are diagrams illustrating an influence of a grating lobe which is given to the listener in a related-art example.

### DETAILED DESCRIPTION OF EMBODIMENTS

### Embodiment

[Whole Configuration]

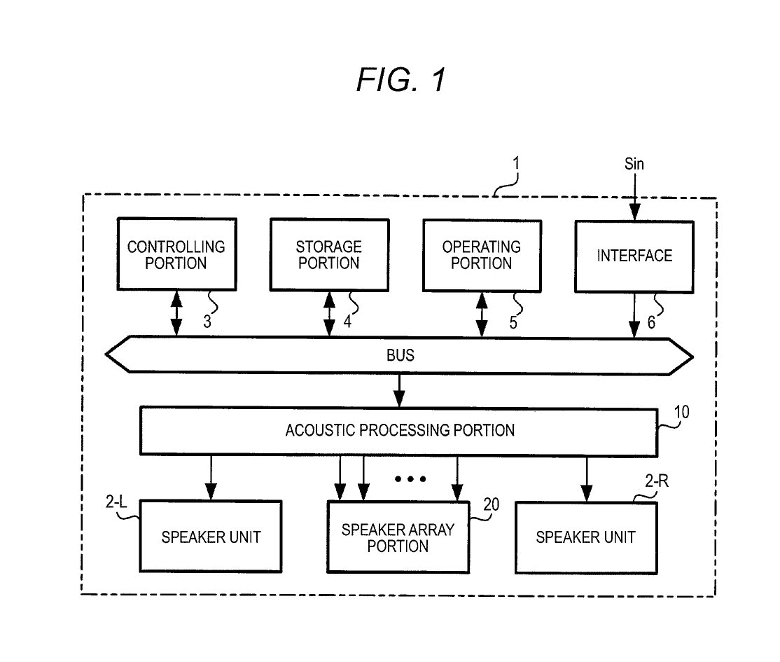

FIG. 1 is a block diagram showing the configuration of a speaker apparatus 1 of an embodiment of the invention. The speaker apparatus 1 has a controlling portion 3, a storage portion 4, an operating portion 5, an interface 6, and an acoustic processing portion 10. These components are connected to one another through a bus. Speaker units 2-L, 2-R, and a speaker array portion 20 which has a plurality of speaker units are connected to the acoustic processing portion 10. The speaker apparatus 1 outputs sounds from the speaker array portion 20, and also from the speaker units 2-L, 2-R. In the sounds output from the speaker array portion 20, a directed sound is referred to as a sound beam.

The controlling portion 3 has a CPU (Central Processing Unit), a RAM (Random Access Memory), a ROM (Read Only Memory), and the like. The controlling portion 3 executes control programs and the like stored in the storage portion 4 or the ROM, thereby controlling various portions of the speaker apparatus 1 via the bus. For example, the controlling portion 3 controls the acoustic processing portion 10, and functions also as setting means for setting parameters in processes conducted in the acoustic processing portion 10, and the like.

The storage portion 4 is storage means such as a nonvolatile memory, and stores set parameters to be used in the control of the controlling portion 3, and the like. The set parameters include a parameter which is set in the acoustic processing portion 10 in accordance with the direction in which the sound beam is output.

Also measurement information of: the time which is required for the sound beam output from the speaker apparatus 1 to be reflected from a wall of the room 1000 to reach a sound receiving point where the listener 2000 is located (in the case of the left wall reflection, referred to as the arrival time L, and, in the case of the right wall reflection, referred to as the arrival time R); the direction of the output of the sound beam which allows the sound beam to reach the sound receiving point (in the case of the left wall reflection, referred to as the output direction L, and, in the case of the right wall reflection, referred to as the output direction R); the time which is required for the sound beam output from the speaker apparatus 1 to directly reach the sound receiving point (the arrival time C); and the direction of the output of the sound beam at this time (the output direction C) is stored in the storage portion 4.

The measurement information is calculated from a result of a measurement in which the sound beam is output from the speaker apparatus 1 placed in the room 1000, and a sound input to a microphone that is previously disposed at the sound receiving point is measured while changing the output direction. The measurement is performed when the environment such as the position where the speaker apparatus 1 is placed, the room where the speaker apparatus is placed, or the sound receiving point is changed, and started in response to an operation by the user on the operating portion 5.

The operating portion 5 has operating means such as a volume for adjusting the sound volume level, and an operation button for inputting instructions for changing the setting, and supplies information indicative of the operation contents, to the controlling portion 3.

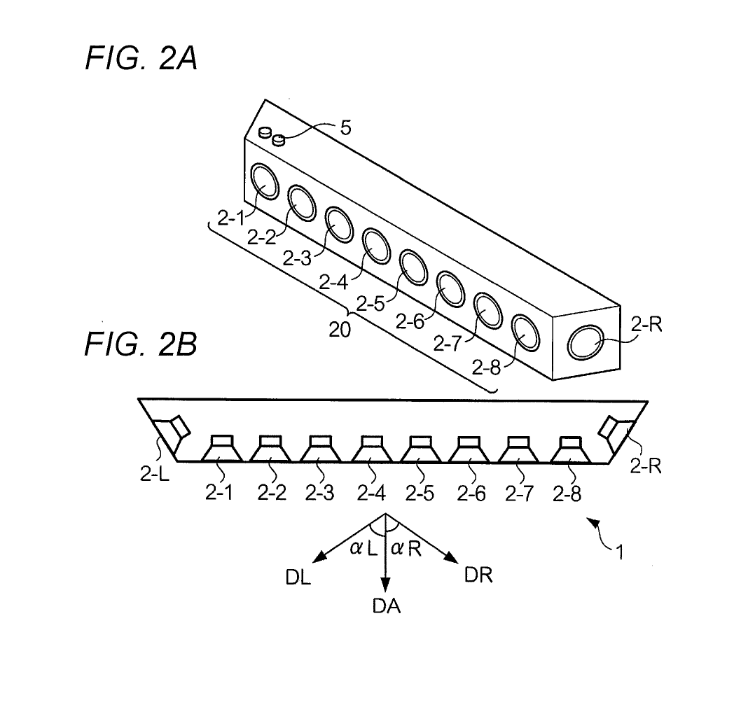

The interface 6 is configured by an input terminal for obtaining an audio signal Sin from the outside, and the like. Then, the speaker units 2-L, 2-R, and the speaker array portion 20 which has a plurality of speaker units will be described with reference to FIG. 2.

[Arrangement of Speaker Units]

FIGS. 2A and 2B are views showing the appearance of the speaker apparatus 1 of the embodiment of the invention, and the manner of arranging the speaker units. FIG. 2A shows the appearance of the speaker apparatus 1, and FIG. 2B is a view showing the arrangement of the speaker units of the speaker apparatus 1 as seen from the upper side of the apparatus. In this example, the speaker apparatus 1 has an approximately trapezoidal shape as viewed from the upper side of the apparatus, and the upper base direction coincides with the front direction of the apparatus, which is the direction in which the frontage of the apparatus faces.

As shown in FIG. 2A, the speaker apparatus 1 has, in the front direction of the apparatus itself, the plurality of speaker units (in the example, eight speaker units 2-1, 2-2, . . . , 2-8) constituting a speaker array portion 20 (first speaker unit group). The speaker apparatus 1 further has the speaker unit 2-L (second speaker unit) in the side face on the left side of the speaker unit 2-1 as viewed from the front of the apparatus, and the speaker unit 2-R (second speaker unit) in the side face on the right side of the speaker unit 2-8. Each of the speaker units 2-L, 2-R may not be single but plural.

As shown in FIG. 2B, the front directions of the speaker units 2-1, 2-2, . . . , 2-8 which are the directions in which the frontages of the speaker units 2-1, 2-2, . . . , 2-8 face (for example, directions of the sound axes) are directed in the direction DA, and arranged in one direction (the horizontal direction in the case where the speaker apparatus 1 is disposed) to constitute the speaker array portion 20. In the speaker array portion 20, sounds are output from the speaker units 2-1, 2-2, . . . , 2-8, whereby the sound beam can be output in a specific direction along the horizontal plane.

The speaker unit 2-L is placed while directing the front direction, which is the direction in which the frontage faces, in the direction DL. The angle formed by the directions DA and DL is indicated by μL. It is assumed that, in the example, the angle μL is 60°. The speaker unit 2-R is placed while directing the front direction, which is the direction in which the frontage faces, in the direction DR. The angle formed by the directions DA and DR is indicated by μR. It is assumed that, in the example, the angle μR is 60°. Preferably, both the angles μL and μR may be larger than 0° and equal to or smaller than 90°.

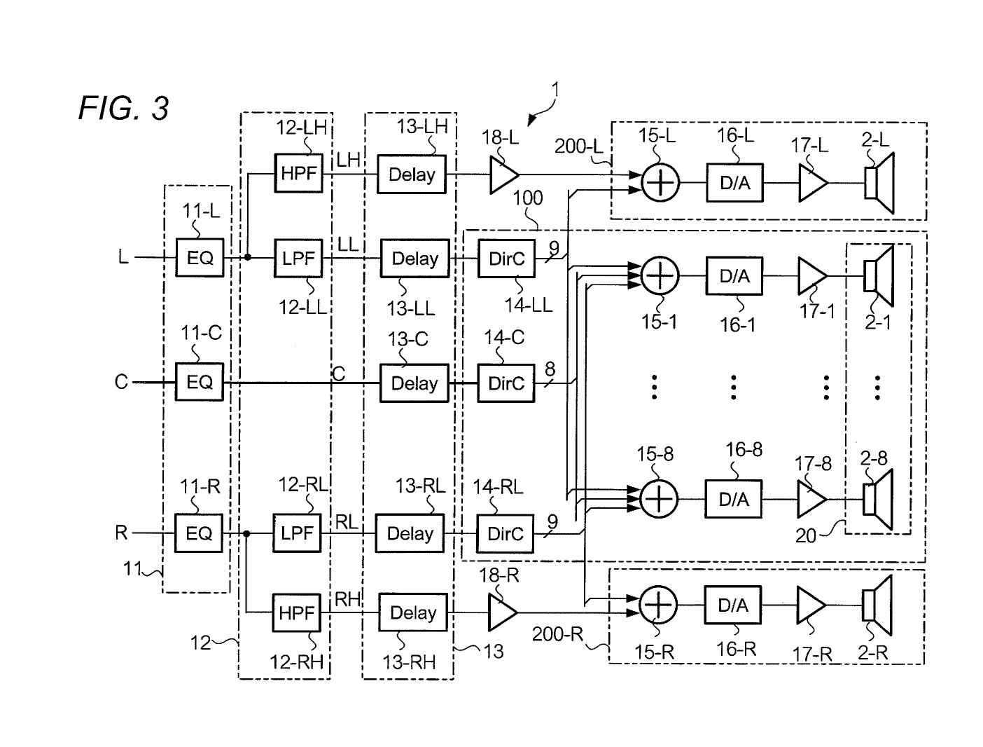

These speaker units may all be of the same kind of speaker units or different kinds of speaker units. Then, the configuration of the acoustic processing portion 10 will be described with reference to FIG. 3.

[Configuration of Acoustic Processing Portion 10]

FIG. 3 is a diagram illustrating the configuration of the acoustic processing portion 10 in the embodiment of the invention. The acoustic processing portion 10 has an equalizer portion (EQ) 11, a supplying portion 12, a delay portion (Delay) 13, level adjusting portions 18-L, 18-R, a first outputting portion 100, and second outputting portions 200-L, 200-R.

The acoustic processing portion 10 obtains the audio signal Sin supplied from the interface 6. In the example, the acoustic processing portion 10 handles the obtained audio signal Sin as three-channel audio signals of channels C, L, R. In the case where the obtained audio signal Sin is configured by channels the number of which is larger than three, such as 5.1 channels, down mixing may be performed, or processing paths similar to those for the channel L, R may be additionally disposed for channels SL, SR in addition to the configuration shown in FIG. 3, and the five channels may be separately processed. In the case where the obtained audio signal Sin is configured by two channels, the channel C may not be used, or the channels may be expanded by matrix decoding or the like, and then the resulting signal may be supplied to the acoustic processing portion 10.

The equalizer portion 11 has equalizer portions 11-C, 11-L, 11-R. The equalizer portions 11-C, 11-L, 11-R obtain the audio signals of the channels C, L, R, provide the frequency characteristics set by the controlling portion 3 to the signals, and then output the resulting signals, respectively. Hereinafter, the audio signal which is output from the equalizer portion 11-C is referred to as the audio signal C.

The supplying portion 12 has high-pass filter portions (HPF) 12-LH, 12-RH, and low-pass filter portions (LPF) 12-LL, 12-RL in each of which the cutoff frequency Fc is preset, and separates the supplied audio signal into audio signals of high- and low-frequency bands.

The high-pass filter portion 12-LH obtains the audio signal output from the equalizer portion 11-L, outputs an audio signal of the high-frequency band in which the components of the frequency band that is equal to or lower than the cutoff frequency Fc (second frequency) set by the controlling portion 3 are attenuated, and supplies the resulting signal to a signal line connected to the second outputting portion 200-L. The high-pass filter portion 12-RH obtains the audio signal output from the equalizer portion 11-R, outputs an audio signal of the high-frequency band in which the components of the frequency band that is equal to or lower than the cutoff frequency Fc set by the controlling portion 3 are attenuated, and supplies the resulting signal to a signal line connected to the second outputting portion 200-R. Hereinafter, the audio signals which are output from the high-pass filter portions 12-LH, 12-RH are referred to as audio signals LH, RH, respectively.

The low-pass filter portion 12-LL obtains the audio signal output from the equalizer portion 11-L, outputs an audio signal of the low-frequency band in which the components of the frequency band that is equal to or higher than the cutoff frequency Fc (first frequency) set by the controlling portion 3 are attenuated, and supplies the resulting signal to a signal line connected to a directionality controlling portion (DirC) 14-LL of the first outputting portion 100. The low-pass filter portion 12-RL obtains the audio signal output from the equalizer portion 11-R, outputs an audio signal of the low-frequency band in which the components of the frequency band that is equal to or higher than the cutoff frequency Fc set by the controlling portion 3 are attenuated, and supplies the resulting signal to a signal line connected to a directionality controlling portion 14-RL of the first outputting portion 100. Hereinafter, the audio signals which are output from the low-pass filter portions 12-LL, 12-RL are referred to as audio signals LL, RL, respectively.

The supplying portion 12 outputs the audio signal C output from the equalizer portion 11-C, without passing the signal through the filters, and supplies the signal to a signal line connected to a directionality controlling portion 14-C of the first outputting portion 100.

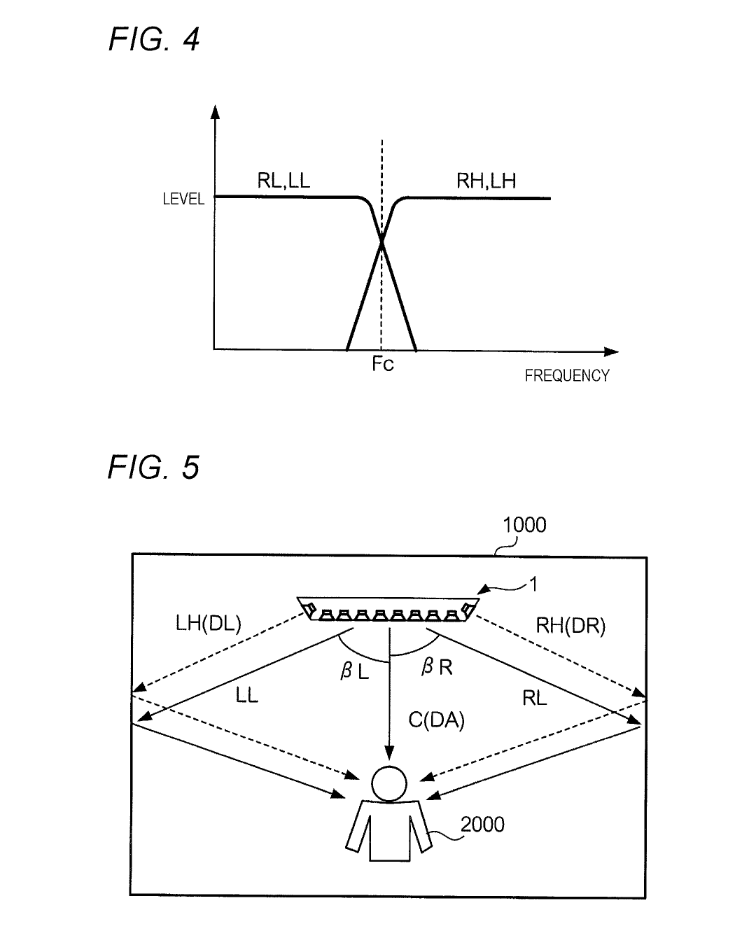

FIG. 4 is a view illustrating frequency characteristics of the high-pass filter portions 12-LH, 12-RH, and low-pass filter portions 12-LL, 12-RL in the embodiment of the invention. The cutoff frequency Fc is determined so that an influence of a grating lobe does not prominently appear to the listener 2000. Namely, the cutoff frequency Fc is determined in accordance with the gap of the speaker units in the speaker array portion 20, or a lower frequency as the gap is wider. In the example, the cutoff frequency Fc (the first and second frequencies) is set to the same value in all the filters. However, the frequency is not required to always use the same value. For example, the first and second frequencies may not be equal to each other, and the first frequency may be higher or lower than the second frequency. The frequency which is determined to be lower as the gap of the speaker units in the speaker array portion 20 is wider is the cutoff frequency Fc (first frequency) which is set in the low-pass filter portions 12-LL, 12-RL. The cutoff frequency Fc (second frequency) which is set in the high-pass filter portions 12-LH, 12-RH is not always required to be determined in accordance with the gap. In this way, a cutoff frequency Fcl corresponding to the first frequency, and a cutoff frequency Fch corresponding to the second frequency may be independently set by the controlling portion 3 in the low-pass filter portions 12-LL, 12-RL, and the high-pass filter portions 12-LH, 12-RH, respectively.

When the frequency characteristics such as shown in FIG. 4 are set in the high-pass filter portions 12-LH, 12-RH, and the low-pass filter portions 12-LL, 12-RL, the audio signals LH, RH of the high-frequency band, and the audio signals LL, RL of the low-frequency band are output from the supplying portion 12.

Returning to FIG. 3, the description is continued. The delay portion 13 has delay portions 13-C, 13-LH, 13-RH, 13-LL, 13-RL. The delay portion 13-C is disposed in the signal line connected to the directionality controlling portion 14-C of the first outputting portion 100, and the delay time is set by the controlling portion 3. The delay portion 13-C delays the audio signal C supplied to the signal line, by the preset delay time. As the delay time, the difference between the longer one of the arrival times R, L indicated by the measured time stored in the storage portion 4, and the arrival time C is set.

The delay portions 13-LH, 13-RH, 13-LL, 13-RL are disposed in signal lines connected to the second outputting portions 200-L, 200-R, and the directionality controlling portions 14-LL, 14-RL of the first outputting portion 100, respectively, and their delay times are set by the controlling portion 3. As the delay time which is set in the delay portions 13-LL, 13-LH, the difference between the longer one of the arrival times R, L indicated by the measured time stored in the storage portion 4, and the arrival time L is set. When the arrival time L is longer than the arrival time R, therefore, “0” is set. As the delay time which is set in the delay portions 13-RL, 13-RH, the difference between the longer one of the arrival times R, L indicated by the measured time stored in the storage portion 4, and the arrival time R is set. When the arrival time R is longer than the arrival time L, therefore, “0” is set.

The level adjusting portions 18-L, 18-R are disposed in signal lines connected to the second outputting portions 200-L, 200-R, and amplify the audio signals LH, RH by an amplification factor which is set by the controlling portion 3, respectively. As described above, each of sounds indicative of the audio signals LH, RH is output from one speaker unit, but sounds indicative of the audio signals LL, RL are output from the plurality of speaker units, and hence there is a difference between the output levels. Therefore, the level adjusting portions 18-L, 18-R adjust the output levels of the audio signals LH, RH so as to be larger than those of the audio signals LL, RL. The amplification factor which is set in the level adjusting portion 18-L, 18-R is set so as to compensate the difference of the output levels. Namely, the amplification factor is determined in accordance with the number of speaker units constituting the speaker array portion 20.

The first outputting portion 100 has the directionality controlling portions 14-C, 14-LL, 14-RL. Furthermore, the first outputting portion 100 has: the speaker units 2-1, 2-2, . . . , 2-8; and, on the signal lines connected to the speaker units, adding portions 15-1, 15-2, . . . , 15-8, digital/analog converting portions (D/A) 16-1, 16-2, . . . , 16-8, and amplifying portions 17-1, 17-2, . . . , 17-8.

Each of the second outputting portions 200-L, 200-R has: the speaker unit 2-L or 2-R; and, on a signal line connected to the speaker unit, an adding portion 15-L or 15-R, a digital/analog converting portion (D/A) 16-L or 16-R, and an amplifying portion 17-L or 17-R.

Each of the adding portions 15-1, 15-2, . . . , 15-8, 15-L, 15-R adds supplied audio signals together. Each of the digital/analog converting portions 16-1, 16-2, . . . , 16-8, 16-L, 16-R converts the supplied digital audio signal to an analog audio signal. Each of the amplifying portions 17-1, 17-2, . . . , 17-8, 17-L, 17-R amplifies the supplied audio signal by the amplification factor according to the volume level designated by the operating portion 5.

The directionality controlling portion 14-C supplies the audio signal C to the signal lines respectively connected to the speaker units 2-1, 2-2, . . . , 2-8. At this time, the directionality controlling portion 14-C performs a delaying process, level adjusting process, and like which correspond to parameters that are set by the controlling portion 3 in accordance with the output direction C indicated by the measurement information, on the audio signal C supplied to the signal lines, and outputs the signal. When the audio signal C is processed in this way, the sound which is output from the speaker array portion 20, and which indicates the audio signal C is output as a sound directed in the output direction C. At this time, the signal may be output also to the signal lines connected to the outputting portions 200-L (the speaker unit 2-L), 200-R (the speaker unit 2-R), to be output as a sound directed in the output direction C from the whole speaker units. In this case, the sweet spot of the center channel (the channel C) is wider as compared with the case where only the speaker array portion 20 is used, and hence perceptibility of dialogs can be improved.

The directionality controlling portion 14-LL supplies the audio signal LL to the signal lines respectively connected to the speaker units 2-1, 2-2, . . . , 2-8, and the speaker unit 2-L. At this time, the directionality controlling portion 14-LL performs a delaying process, level adjusting process, and like which correspond to parameters that are set by the controlling portion 3 in accordance with the output direction L indicated by the measurement information, on the audio signal LL supplied to the signal lines, and outputs the signal. When the audio signal LL is processed in this way, the sound which is output from the speaker array portion 20, and which indicates the audio signal LL is output as a sound directed in the output direction L. The directionality controlling portion 14-LL may not supply the audio signal LL to the signal line connected to the speaker unit 2-L, or may supply the signal also to the signal line connected to the speaker unit 2-R. In the case that the audio signal LL is supplied to the signal line connected to the speaker unit 2-L, the audio signal LL may be mixed with the audio signal LH at a predetermined ratio. In the case that the audio signal LL is supplied to the signal line connected to the speaker unit 2-R, the audio signal LL may be mixed with the audio signal RH at a predetermined ratio.

The directionality controlling portion 14-RL supplies the audio signal RL to the signal lines respectively connected to the speaker units 2-1, 2-2, . . . , 2-8, and the speaker unit 2-R. At this time, the directionality controlling portion 14-RL performs a delaying process, level adjusting process, and like which correspond to parameters that are set by the controlling portion 3 in accordance with the output direction R indicated by the measurement information, on the audio signal RL supplied to the signal lines, and outputs the signal. When the audio signal RL is processed in this way, the sound which is output from the speaker array portion 20, and which indicates the audio signal RL is output as a sound directed in the output direction R. The directionality controlling portion 14-RL may not supply the audio signal RL to the signal line connected to the speaker unit 2-R, or may supply the signal also to the signal line connected to the speaker unit 2-L. In the case that the audio signal RL is supplied to the signal line connected to the speaker unit 2-R, the audio signal RL may be mixed with the audio signal RH at a predetermined ratio. In the case that the audio signal RL is supplied to the signal line connected to the speaker unit 2-L, the audio signal RL may be mixed with the audio signal LH at a predetermined ratio.

In the above, the configuration of the acoustic processing portion 10 has been described.

[Path of Sound Beam]

FIG. 5 is a view illustrating paths of sounds output from the speaker apparatus 1 of the embodiment of the invention, to the listener 2000. It is assumed that, as shown in FIG. 5, the listener 2000 (the sound receiving point) is in front of the speaker apparatus 1 disposed in the room 1000. In this state, the speaker apparatus 1 performs a measurement for determining the measurement information, and stores the measurement information in the storage portion 4. In this case, the output direction C indicated by the measurement information coincides with the direction DA which is the front direction of the speaker units 2-1, 2-2, . . . , 2-8. The output directions L, R indicated by the measurement information are directions of the angles βL and βR with respect to the direction DA, respectively.

When the audio signal Sin is input, the speaker apparatus 1 outputs a sound beam C indicating the audio signal C in the output direction C, and sound beams LL, RL indicating the audio signal LL, RL in the directions of the angles βL and βR with respect to the output direction, so as to cause the sound beams to reach the listener 2000. The sound signals have undergone the delaying process in the delay portion 13. Even when the path lengths of the sound beams LL, RL, C are different from one another, therefore, sounds which are to be listened at the same timing reach the listener 2000 at a substantially same timing.

In the sound beams LL, RL, the components of the high-frequency band which is equal to or higher than the cutoff frequency Fc that is determined in accordance with the gap of the speaker units of the speaker array portion 20 are attenuated. Even when, in order to reduce the cost, the number of speaker units is reduced and the gap of speaker units is widened, therefore, a grating lobe hardly occurs, so that the components of the audio signals L, R are suppressed from directly reaching from the speaker apparatus 1, whereby the localization sensation of a sound image can be maintained.

The speaker units 2-L, 2-R output sounds LH, RH indicating the audio signals LH, RH, respectively. The sounds LH, RH have a directionality which is not so high as the sound beam generated by the speaker array portion 20, and are output approximately in the front directions DL, DR of the speaker units 2-L, 2-R, respectively. The directions DL, DR are directions which are obtained by rotating the direction DA by 60° (μL, μR), and hence the sounds LH, RH are reflected by the wall to reach the listener 2000. Since the sound signals have undergone the delaying process in the delay portion 13, the sound LH and the sound beam LL reach the listener 2000 at substantially the same time, and the sound RH and the sound beam RL reach the listener 2000 at substantially the same time. Therefore, the listener 2000 can listen the components of the high-frequency band which are attenuated in the sound beams LL, RL, as the sounds LH, RH, so that the localization sensation of a sound image is prevented from being impaired, while deterioration of the sound quality is suppressed, whereby a surround feeling can be obtained.

Depending on conditions such as the position where the speaker apparatus 1 is disposed, the position of the listener 2000, or the shape of the room 1000, there occasionally is a case where μL and do not coincide with each other. Even in this case, the sound LH is not so high in directionality, and is transmitted while spreading in a certain area, so that the sound is transmitted also to the listener 2000. This is applicable also to the sound RH.

<Modifications>

Although, in the above, the embodiment of the invention has been described, the invention can be executed in various manners as described below.

[Modification 1]

In the embodiment described above, in the case where the sound LH and the sound beam LL are output at different angles with respect to the direction DA, i.e., the case where the front direction of the speaker 2-L is different from the direction in which the sound beam LL is output, the controlling portion 3 may control the acoustic processing portion 10 so that the relationship of the output level of the sound LH and that of the sound beam LL is changed depending on the degree of the difference.

The larger the difference between the front direction of the speaker 2-L and the direction in which the sound beam LL is output is, the farther the position of the listener 2000 is separated from the center of the range where the sound LH reaches, and hence the sound volume at which the listener 2000 can listen the sound is further lowered. Therefore, the output level of the sound LH may be raised so as to compensate the reduction. In this case, for example, the controlling portion 3 may perform the control so that the amplification factor of the amplifying portion 17-L is increased. The configuration is not limited to this. Any configuration may be employed as far as the sound LH can be output at a higher level. At this time, in place of or together with the increase of the output level of the sound LH, the controlling portion 3 may lower the output level of the sound beam LL. Alternatively, the amplification factor which is set in the level adjusting portion 18-L may be controlled.

The configuration of Modification 1 may be applied also to the relationship of the sound RH and the sound beam RL, in a similar manner as that of the sound LH and the sound beam LL.

In the case where the front direction of the speaker 2-L is largely different from the direction in which the sound beam LL is output, and the listener 2000 is located outside the range where the sound LH reaches, the low-pass filter portion 12-LL in the configuration shown in FIG. 3 may be bypassed so that the audio signal does not pass therethrough, and the whole band is output as a sound beam, and then the output of the sound LH from the speaker 2-L may be stopped.

[Modification 2]

In the embodiment described above, the controlling portion 3 may determine the values of the cutoff frequencies Fc which are set in the filters of the supplying portion 12, in accordance with the relationship of the direction in which the sound beam LL is output, and that in which the sound beam C is output, i.e., that in which the listener 2000 is located. Specifically, as the angle between the direction in which the sound beam LL is output, and that in which the listener 2000 is located is larger, a sound beam generated by a grating lobe becomes more likely to reach the listener 2000. In order to suppress the grating lobe, therefore, the controlling portion 3 may determine that the values of the cutoff frequencies Fc are small. By contrast, as the angle between the direction in which the sound beam LL is output, and that in which the listener 2000 is located is smaller, a grating lobe in a band which affects the localization becomes less likely to reach the listener. In this case, the controlling portion may determine that the value of the cutoff frequency Fc is large so that a high directionality due to the sound beam can be used to a maximum extent. Here, the cutoff frequencies Fc are the cutoff frequency Fc (the first frequency) which is set in the low-pass filter portions 12-LL, 12-RL. The cutoff frequency Fc (the second frequency) which is set in the high-pass filter portions 12-LH, 12-RH is not always required to be determined in accordance with the relationship of the direction in which the sound beam LL is output, and that in which the sound beam C is output.

The configuration of Modification 2 may be similarly applied also to the sound beam RL. Therefore, there is a case where the cutoff frequencies Fc which are set in the filters of the supplying portion 12 do not have the same value. For example, the cutoff frequency Fc which is set in the high-pass filter portion 12-LH may be different from that which is set in the high-pass filter portion 12-RH.

[Modification 3]

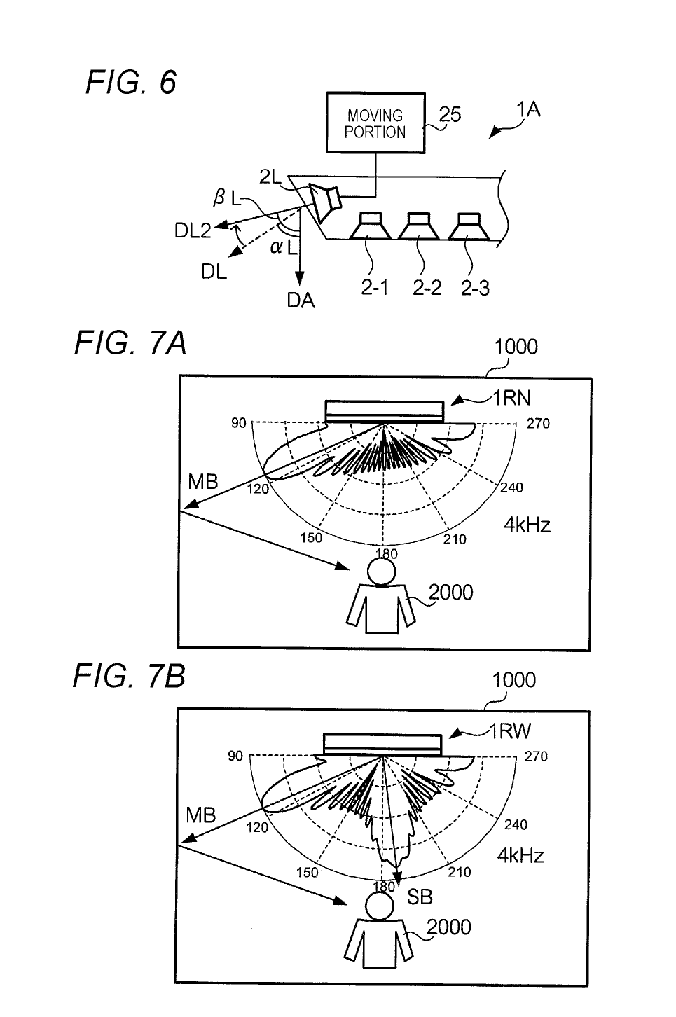

The embodiment described above may be configured as a speaker apparatus 1A in which the angle μL can be changed by rotating the front direction DL of the speaker unit 2-L. In this case, the speaker apparatus 1A has the configuration shown in FIG. 6.

FIG. 6 is a diagram illustrating the configuration of the speaker apparatus 1A of Modification 3 of the invention. As shown in FIG. 6, a moving portion 25 is connected to the speaker unit 2-L. Under the control of the controlling portion 3, the moving portion 25 rotates the front direction DL of the speaker unit 2-L. The controlling portion 3 controls the moving portion 25 in correspondence with the direction in which the sound beam LL is output, so that the front direction of the speaker unit 2-L is moved to the direction DL2 in which the sound beam LL is output. Namely, the controlling portion 3 controls the moving portion 25 so that the angle formed by the directions DL2 and DA becomes the angle βL.

According to the configuration, in the speaker apparatus 1A, the direction in which the sound beam LL is output can be made the same with that in which the sound LH is output.

The configuration of Modification 3 is similarly applicable also to the speaker unit 2-R.

[Modification 4]

In the embodiment described above, the speaker units 2-L, 2-R are placed on the both sides of the speaker array portion 20. Alternatively, the speaker units may be placed at positions other than the above. For example, the speaker units 2-L, 2-R may be placed in an upper or lower part of the speaker array portion 20. It is requested that the front directions of the speaker units 2-L, 2-R are different from those of the speaker units constituting the speaker array portion 20. Preferably, the front directions of the speaker units 2-L, 2-R are included in a controllable range of the direction in which the sound beam is output from the speaker array portion 20.

One of the speaker units 2-L, 2-R may be omitted.

[Modification 5]

In the embodiment described above, the speaker units constituting the speaker array portion 20 are arranged in one row. Alternatively, the speaker units may be arranged in two or more rows.

[Modification 6]

The control programs in the embodiment described above may be provided in a state where the programs are stored in a computer readable storage medium such as a magnetic storage medium (a magnetic tape, a magnetic disk, or the like), an optical storage medium (an optical disk or the like), a magnetooptical storage medium, or a semiconductor memory. Alternatively, the speaker apparatus 1 may download the control programs via a network.

According to an aspect of the invention, even when a speaker array apparatus is used in which the gap of speaker units is widened and the number of used speaker units is reduced, the localization sensation of a sound image is prevented from being impaired, while deterioration of the sound quality is suppressed, whereby a surround feeling can be obtained.

What is claimed is:

1. A speaker apparatus comprising:
a first outputting unit that has a first speaker unit group in which a plurality of speaker units are arranged, and that outputs a supplied audio signal from the first speaker unit group as a sound which is directed in a direction;
a second outputting unit that has a second speaker unit which is placed so that a front direction of the second speaker unit in which a frontage of the second speaker unit faces is different from a front direction of the first speaker unit group in which a frontage of the first speaker unit group faces, and that outputs a supplied audio signal from the second speaker unit as a sound; and
a supplying unit that separates an input audio signal into an audio signal in a low-frequency band where a frequency band which is higher than a first frequency is attenuated, and an audio signal in a high-frequency band where a frequency band which is lower than a second frequency is attenuated, the supplying unit that supplies the audio signal in the low-frequency band to the first outputting unit, and that supplies the audio signal in the high-frequency band to the second outputting unit.

2. The speaker apparatus according to claim 1, wherein
the audio signal in the low-frequency band is mixed with the audio signal in the high-frequency band which is to be output to the second outputting unit, at a predetermined ratio.

3. The speaker apparatus according to claim 1, wherein
a relationship between an output level of the sound output from the first outputting unit and an output level of the sound output from the second outputting unit is changed in accordance with a relationship between the direction in which the sound output from the first outputting unit is directed and the front direction of the second speaker unit.

4. The speaker apparatus according to claim 2, wherein
a relationship between an output level of the sound output from the first outputting unit and an output level of the sound output from the second outputting unit is changed in accordance with a relationship between the direction in which the sound output from the first outputting unit is directed and the front direction of the second speaker unit.

5. The speaker apparatus according to claim 1, wherein
the first frequency is determined in accordance with a relationship between the direction in which the sound output from the first outputting unit is directed and a position which the sound is to reach.

6. The speaker apparatus according to claim 2, wherein
the first frequency is determined in accordance with a relationship between the direction in which the sound output from the first outputting unit is directed and a position which the sound is to reach.

7. The speaker apparatus according to claim 3, wherein
the first frequency is determined in accordance with a relationship between the direction in which the sound output from the first outputting unit is directed and a position which the sound is to reach.

8. The speaker apparatus according to claim 4, wherein
the first frequency is determined in accordance with a relationship between the direction in which the sound output from the first outputting unit is directed and a position which the sound is to reach.

9. The speaker apparatus according to claim 1 further comprising:
a setting unit that sets the direction in which the sound output from the first outputting unit is directed; and
a moving unit that moves the front direction of the second speaker unit to a direction corresponding to the direction set by the setting unit.

10. The speaker apparatus according to claim 2 further comprising:
a setting unit that sets the direction in which the sound output from the first outputting unit is directed; and
a moving unit that moves the front direction of the second speaker unit to a direction corresponding to the direction set by the setting unit.

11. The speaker apparatus according to claim 3 further comprising:
a setting unit that sets the direction in which the sound output from the first outputting unit is directed; and
a moving unit that moves the front direction of the second speaker unit to a direction corresponding to the direction set by the setting unit.

12. The speaker apparatus according to claim 4 further comprising:
a setting unit that sets the direction in which the sound output from the first outputting unit is directed; and
a moving unit that moves the front direction of the second speaker unit to a direction corresponding to the direction set by the setting unit.

13. The speaker apparatus according to claim 5 further comprising:
a setting unit that sets the direction in which the sound output from the first outputting unit is directed; and
a moving unit that moves the front direction of the second speaker unit to a direction corresponding to the direction set by the setting unit.

14. The speaker apparatus according to claim 6 further comprising:
a setting unit that sets the direction in which the sound output from the first outputting unit is directed; and
a moving unit that moves the front direction of the second speaker unit to a direction corresponding to the direction set by the setting unit.

15. The speaker apparatus according to claim 7 further comprising:
a setting unit that sets the direction in which the sound output from the first outputting unit is directed; and
a moving unit that moves the front direction of the second speaker unit to a direction corresponding to the direction set by the setting unit.

16. The speaker apparatus according to claim 8 further comprising:
a setting unit that sets the direction in which the sound output from the first outputting unit is directed; and
a moving unit that moves the front direction of the second speaker unit to a direction corresponding to the direction set by the setting unit.
